(19) United States
(12) Patent Application Publication
(10) Pub. No.: US 2023/0356420 A1
(43) Pub. Date: Nov. 9, 2023

(54) Curved moving hair-cutting blades with triangular static blades for fade hair-cutting

(71) Applicant: Janis Hoffäller, Berlin (DE)

(72) Inventor: Janis Hoffäller, Berlin (DE)

(21) Appl. No.: 17/735,234

(22) Filed: May 3, 2022

(51) Int. Cl. B26B 19/38; B26B 19/20; B26B 19/06

(52) U.S. Cl. CPC B26B 19/3846; B26B 19/20; B26B 19/06

(57) ABSTRACT

The present invention discloses an advanced assembly for perfect hair fading by a user without a specialized hairstylist. The apparatus works in conjunction with a curved or straight moving blade and a triangular static blade, allowing a standardized output without any specialized training and in less time.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a personal grooming system and, more particularly, an architecture that provides curved moving hair-cutting blades with triangular static blades for fade hair-cutting and achieving a perfect fade without requiring any specialized skills. Furthermore, the integrated device provides portability, ease of storage and a standardized viewing angle to allow the best output.

### Description of the Related Art

A “fade” haircut is commonly known as the haircut style on the side of the head, with the hair towards the top of the head being longer than the bottom of the head. The fade consists of different hair lengths gradually getting shorter toward the bottom of the head. Traditional means of applying this haircut are using clippers with different size guards throughout the side of the head and ensuring no apparent differences in hair lengths.

Although various clippers in various styles and designs have been developed in the past and proposed theoretical success, they all have problems in practice. None of them has been successful in marketing. Thus, a need remains to accomplish a new design for a perfect fading device.

By looking at prior art, multiple advancements have been seen in similar regards. For instance, U.S. patent Ser. No. 13/737,943 discloses a progressive comb for haircut fading. The comb gradually gets thicker from bottom to top. This comb is somewhat intended to be used as a traditional comb; however, the width of the comb keeps the hair spaced evenly to ensure a blended fade haircut. The sporadic teeth keep the hair in place while the trimmers cut the hair following the edge guide provided on the comb. This tool gives the stylist (user) the flexibility to provide a shorter or longer fade by adjusting the comb up or down on the head.

A U.S. Pat. No. 5,964,037A on a hair clipper blade system for producing a fade haircut discusses a set of hair cutting blades with an electric buzzer, comprising at least one upper blade and at least one lower blade. The upper blade has a plurality of upper teeth and a short side and side. The upper teeth vary in length such that they gradually increase in length between the short side and the long side. The upper teeth also vary in height such that they gradually increase in height between the short side and the long side. The lower blade has lower teeth uniform in both length and height. The upper blade is mounted to the buzzer directly over the lower blade, and the blades are reciprocated against each other to create a cutting action. By a preferred embodiment, left and right facing upper blades are provided, which form a mirror image of each other such that among both of said blades, the short side and long side are reversed.

A US patent 2,014,0283867A1 on progressive comb for haircut fading aims to provide a seamless fade haircut along the sides and back of the head. The comb guides the hair into the comb to be cut to the desired length as would a standard comb; only the Fade Perfect Comb widens toward the top. The teeth are strategically placed for even hair cutting and ease of movement of the hair. The comb fades by it descending in width while the teeth remain the same length for an even amount of hair to be cut.

Furthermore, there are apparatuses for providing ease of use while using the hair trimmers. For instance, a U.S. Pat. No. 7,051,442B2 on Ear area comb attachment for hair clippers is issued to WAHI CLIPPER Corp Wahl Clipper Corp. The patent relates to an ear area comb attachment for attachment to a hair clipper having a blade set with a moving blade laterally reciprocating relative to a stationary blade, includes a base configured for attachment to the clipper and a guard formation associated with the base for blocking access to a central portion of the blades and defining a cutting area at least one end portion. At least one hair feed guide is associated with the base for guiding hair strands toward the cutting area.

Another patent on a Hair trimmer with comb attachment bearing U.S. Pat. No. 5,050,305A is issued to Remington Corp LLC State Street Bank and Trust Co NA. A power-driven hair trimmer appliance is fitted with a demountable comb attachment with a similar supporting segment but a more extensive configuration than the appliance. A plurality of discrete pressure pads is provided for fitting the comb to the appliance. The comb may be adjusted to any position between predetermined maximum and minimum positions of trim length. At any operating position of the comb, trimmed hair will fall away from the appliance, thereby eliminating the need to interrupt trimming operations to clean the appliance periodically.

Another patent on Hair Cutting Machine bearing US patent 2,011,0232105A1 is issued to Procter and Gamble Co. The patent provides the option of dividing up the hair with one-handed use of the hair cutting machine for a hair cutting machine having a gripping piece, two clipper blades, as well as a drive to generate a relative movement of the clipper blades, it is proposed that a dividing tip be provided on the hair cutting machine and that said dividing tip be connected to the hair cutting machine via a connection.

An electric hair clipper bearing U.S. Pat. No. 7,509,743B2 discloses an electric hair clipper. A pin cam reciprocates a movable blade to perform hair-cutting. A comb cap is attached to the outer surface of the hair clipper body. A drive bolt is mounted in a lower region of the hair clipper body. A tension spring is mounted around the outer peripheral surface of the drive bolt. A nut member is provided to allow the drive bolt to be penetrated through and formed at an inner peripheral surface with screw grooves. A shock-absorbing spring is provided, one end of which is attached to a plate fixed to an inner bottom surface of the body and the other end is attached to a shock-absorbing bar. Up and Down switches are formed at opposite lateral surfaces of the body at the lower ends of the lateral surfaces to forwardly and rearwardly reciprocate the comb cap.

In conclusion, the applicant is unaware of no formerly developed apparatus, system, or method that facilitates the user in the best way possible and provides efficient and effective output.

Looking at the prior art and market requirements, the need exists for an advancement that provides an improved structure while being relatively unobtrusive in a professional or private setting, easily adapted to various settings and locations, and easy to use with minimal training. The proposed assembly provides an improved output, ease of use, saves hair expert time, and easily gives fade in minutes.

None of the previous inventions and patents, taken either singly or in combination, is seen to describe the instant invention as claimed. Hence, the inventor of the present invention proposes to resolve and surmount existent technical difficulties to eliminate the shortcomings mentioned above of prior art.

### SUMMARY

In light of the disadvantages of the prior art, the following summary is provided to facilitate an understanding of some of the innovative features unique to the present invention. It is not intended to be a complete description. A full appreciation of the various aspects of the invention can be gained by taking the entire specification, claims, drawings, and abstract.

it is a general object of the present invention to provide an improved form of assembly which provides an improved assembly to facilitate users achieve perfect fading without specialized training.

More importantly, it is the object of invention to provide an improved hair styling assembly that can be used instead of a regular guard to enable users to achieve a perfectly faded haircut without any skill.

Another object is to provide an improved Hair Grooming Device that is easy to use and can be used with minimal training.

It is another object of the invention to provide a set of hair clipper blades capable of creating angled cuts necessary to accomplish a fade haircut.

It is also the principal object of the invention to provide two curved moving blades and two triangular static blades. The combination of these blades is used for fade hair-cutting.

It is also the objective of the invention to provide the perfect fade, being adjustable to the hairstylist, customer, or user, and reducing the amount of time spent providing a fade style haircut on the site of the head.

According to another aspect, it is also the objective of the invention to provide an assembly which produces high-quality output.

It is also the object of the invention to provide a reasonably priced assembly. It has high-reliability factors and is small in weight and size, making it portable and easy to travel with or stow in most bathroom drawers.

It is also the objective of the invention to provide an assembly which is of durable configuration made of high-quality material. The inner parts of the assembly can sustain the high working temperature and repeated usage.

Other aspects, advantages and novel features of the present invention will become apparent from the detailed description when considered in conjunction with the accompanying drawings.

This summary is provided merely to summarise some example embodiments to provide a basic understanding of some aspects of the subject matter described herein. Accordingly, it will be appreciated that the above-described features are merely examples and should not be construed to narrow the scope or spirit of the subject matter described herein. Other features, aspects, and advantages of the subject matter described herein will become apparent from the detailed description, figures, and claims.

### BRIEF DESCRIPTION OF THE DRAWINGS

The accompanying figures, where like reference numerals refer to identical or functionally similar elements throughout the separate views, together with the detailed description below, are incorporated in and form part of the specification and serve to illustrate further embodiments of concepts that include the claimed invention and explain various principles and advantages of those embodiments.

FIG. 1 shows the proposed design of blades when the actual blades are on top of each other as per preferred embodiments of the invention.

FIG. 2 shows the proposed design of blades where the blade will be on the scalp a 900 as per preferred embodiments of the invention.

FIG. 3 shows the proposed design of the W2 blade, as per preferred embodiments of the invention.

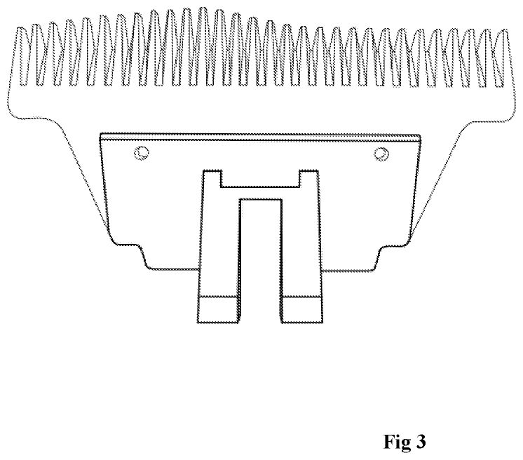

FIG. 4 shows the proposed design of the W3 blade, as per preferred embodiments of the invention.

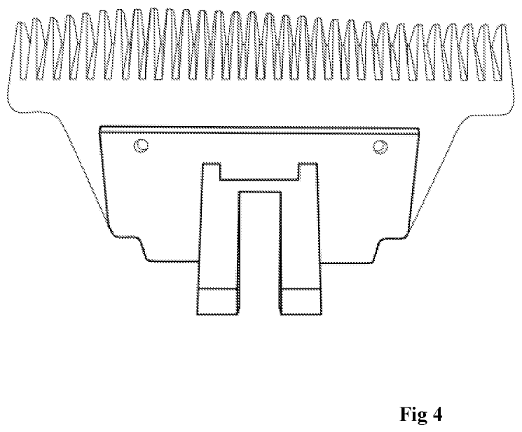

FIG. 5 shows the proposed design of the G2 blade as per preferred embodiments of the invention.

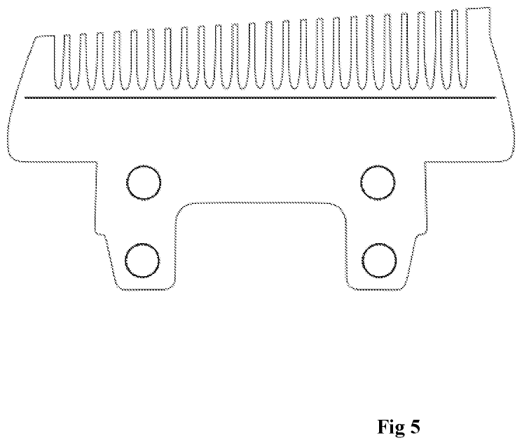

FIG. 6 shows the proposed design of the G3 blade as per preferred embodiments of the invention.

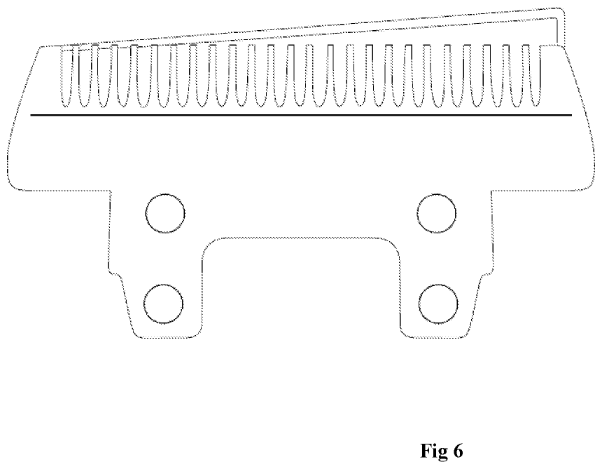

FIG. 7 shows the complete design of the proposed assembly as per preferred embodiments of the invention.

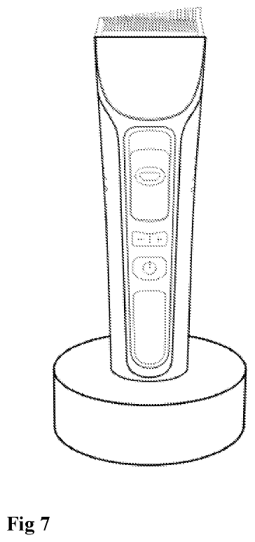

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and a representative basis for teaching one skilled in the art to employ the present invention in virtually any appropriately detailed system, structure or manner.

The terminology used herein is to describe particular embodiments only and is not intended to limit the invention. As used herein, the term “and/or” includes any and all combinations of one or more of the associated listed items. As used herein, the singular forms “a,” “an,” and “the” are intended to include the plural forms as well as the singular forms unless the context indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

The present invention is directed to provide a device with exemplary blades and output to achieve perfect fading.

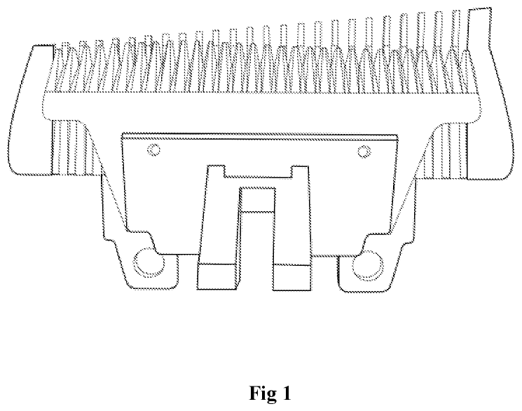

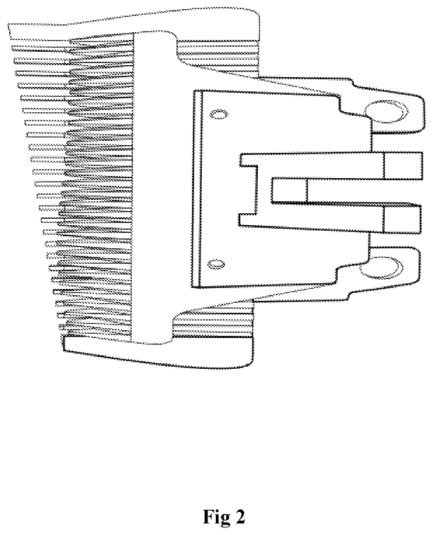

As per its preferred embodiment, this invention creates a system, a method, and an apparatus that comprises-a combination of blades. The curved moving hair-cutting blades work parallel with triangular static blades for fade hair-cutting, as shown in FIGS. 1 and 2.

Users will use the Fade assembly, like a traditional clipper, for a fading haircut. The user holds the tool by the handle and whether the user is left or right-handed. The user starts by determining how long he wants the hair to be from bottom to top and, after determining, can start at the nape of the neck and work way up. The user holds the assembly at desired length around the hairline. Once the user wants to cut further up, just simply comb the hair against the higher part of the head and use the trimmers as before. The person repeats this up and down motion going around their head (left, back, and right sides), ending with a perfectly faded haircut, or “fade” haircut. Using the proposed assembly prevents any line of demarcation and cleans up the neckline, sideburns, eyebrows and behind the ears. This assembly is not intended to be used at the top of the head. Furthermore, the assembly will come with picture instructions to be used properly.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to it without departing from its spirit. Therefore, it is not intended that the scope of the invention be limited to the specific embodiment illustrated and described. Instead, it is intended that the appended claims and their equivalents determine the scope of this invention.

The Abstract of the Disclosure is provided to allow the reader to ascertain the technical disclosure's nature quickly. It is submitted with the understanding that it will not be used to interpret or limit the scope or meaning of the claims. In addition, in the preceding detailed description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus, the following claims are hereby incorporated into the detailed description, with each claim standing on its own as a separately claimed subject matter.

1: A combination of a set of hair cutting blades where an upper blade has a plurality of upper teeth, a short side and alongside, the upper teeth vary in length whereas the teeth gradually increase in length between the short side and long side, the upper teeth vary in height whereas the teeth gradually increase in height between the short side and long side; and a lower blade, the lower blade having a plurality of lower teeth which are uniform in length and height, the upper blade and lower blade are attached to the electric trimmer where the upper blade is located directly over the lower blade such that the upper blade and lower blade are reciprocated to rub against each other to provide a cutting action.

2: A haircutter's curved or straight moving blade in combination with a triangular static blade of a haircutter is used to quickly cut a fade haircut and provides portability when travelling and ease of storage because of its sleek design.

3: The device to be used as clippers to achieve perfect fading:
Device, as per claim 3, provides 14 different types of fade settings;
A device, as per claim 3, requires one swipe action;
The device, as per claim 3, has four different RPM settings;
A device, as per claim 3, provides a premium 7,000 RPM motor;
A device, as per claim 3, provides up to 240 minutes of battery;
A device, as per claim 3, is waterproof;
A device, as per claim 3, is cordless and rechargeable; and,
As per claim 3, a device developed from high-quality material for long-term use.
